(19) United States
(12) Patent Application Publication
(10) Pub. No.: US 2013/0118358 A1
(43) Pub. Date: May 16, 2013

(54) BEVERAGE PREPARATION AND DISPENSING SYSTEM

(71) Applicant: John M. Lown, Huntington Beach, CA (US)

(72) Inventor: John M. Lown, Huntington Beach, CA (US)

(21) Appl. No.: 13/296,041

(22) Filed: Nov. 14, 2011

(51) Int. Cl. A47J 31/44

(52) U.S. Cl. 99/279

(57) ABSTRACT

A beverage preparation and dispensing system includes a container having an open top end; a cover having a bottom portion removably attachable to the top end of the container; at least first and second infusers removably attachable to the bottom of the cover: and a juicer device removably attachable to the top end of the container when the cover is removed. In a specific embodiment, the container includes a container body having an open top, and a lid ring having a bottom portion removably attachable to the open top of the container body and a top portion defining the open top end of the container to which the cover and the juicer are removably attachable. At least a first one of the infusers is configured to hold herbal material. and at least a second one of the infusers is configured to hold crushed fruit or fruit pulp.

### CROSS-REFERENCE TO RELATED APPLICATION

Not applicable.

### FEDERALLY SPONSORED RESEARCH OR DEVELOPMENT

Not applicable.

### BACKGROUND

This disclosure relates to a system for preparing and dispensing various types of beverages. More specifically, it relates to a system comprising a pitcher or the like with several interchangeable attachments for the pitcher that provide for the preparation and dispensing of infused beverages (such as tea and fruit-infused beverages) and freshly-squeezed fruit juice.

The consumption of freshly-prepared beverages, such as tea, herbal tea, fruit-infused water or tea, and freshly-squeezed fruit juice has become increasingly popular. Each type of beverage requires it own preparation technique and apparatus, however. For example. the preparation and dispensing of steeped and infused beverages are facilitated by the use of beverage preparation vessels that incorporate devices known as infusers. For example, steeped beverages, such as tea and herb tea, are customarily brewed by placing the herbal material in a pot, into which is poured hot water. Typically, it is known to provide an infuser configured as a mesh receptacle or basket to confine the herbal material while it is being steeped in the hot water.

Infusers are also used to prepare “infused” beverages that consist essentially of water that is flavored or “infused” with the juice or essence of various fruits. In the case of infused beverages, the infuser is configured as a basket or receptacle that is inserted into a vessel, such as a pitcher, containing a volume of water. The infuser has an interior that holds crushed fruit or fruit pulp, and a side wall with passages or apertures therethrough for the passage of water through the infuser, and the passage of juice from the fruit into the water, whereby the water is flavored by the juice.

Freshly-squeezed fruit juice requires a “juicer,” which is a device that extracts the juice from the fruit, leaving the pulp as a residue to be disposed of. Typically, a juicer comprises a basin with a porous bottom and a central extraction element or reamer configured for entry into the exposed interior of a cut fruit, such as an orange or lemon. The juicer is placed on top of an open container or vessel, and fruit is then manually rotated on the reamer to extract the juice from the pulp. The juice then drains into the container through passages in the bottom of the basin.

A number of popular beverages are combinations of two or more of the above types of beverages, such as, for example, tea combined with freshly-squeezed fruit juice and/or infused fruit juice, or freshly-squeezed juice combined with infused juice. To make such a combination drink, it is necessary to use two different types of infusers (i.e., an herbal infuser and a fruit infuser), or either an infuser and a juicer. Each of these implements may come with its own beverage container, thereby requiring the pouring of the beverage from one container to another as the drink is made. In any event, having a separate apparatus for each of the three types of beverages described above is cumbersome and wasteful of costs and space.

It would therefore be desirable to have a beverage preparation and dispensing system that requires only a single container, and that can be used to prepare any of the types of beverages described above.

### SUMMARY

Broadly, in one aspect, the present disclosure relates to a beverage preparation and dispensing system, comprising a container having an open top end; a cover having a bottom portion removably attachable to the top end of the container; at least first and second infusers removably attachable to the bottom of the cover; and a juicer device removably attachable to the top end of the container when the cover is removed.

In a specific embodiment, the container includes a container body having an open top, and a lid ring having a bottom portion removably attachable to the open top of the container body and a top portion defining the open top end of the container to which the cover and the juicer device are removably attachable. Advantageously, at least a first one of the infusers is configured to hold herbal material, such as tea leaves, and at least a second one of the infusers is configured to hold crushed fruit or fruit pulp.

### BRIEF DESCRIPTION OF THE DRAWINGS

FIG. 1 is a collective perspective view of the major components of a beverage preparation and dispensing system in accordance with this disclosure;

FIG. 2 is an exploded view of a beverage container assembly in accordance with an embodiment of this disclosure, along with one of the infuser baskets used in the container assembly in the beverage preparation and dispensing system of FIG. 1;

FIG. 3 is an exploded view of a cover and two removable infuser baskets in accordance with an embodiment of the system of FIG. 1; and

FIG. 4 is an exploded view of beverage container assembly and a removable juicer device in accordance with an embodiment of the system of FIG. 1.

### DETAILED DESCRIPTION

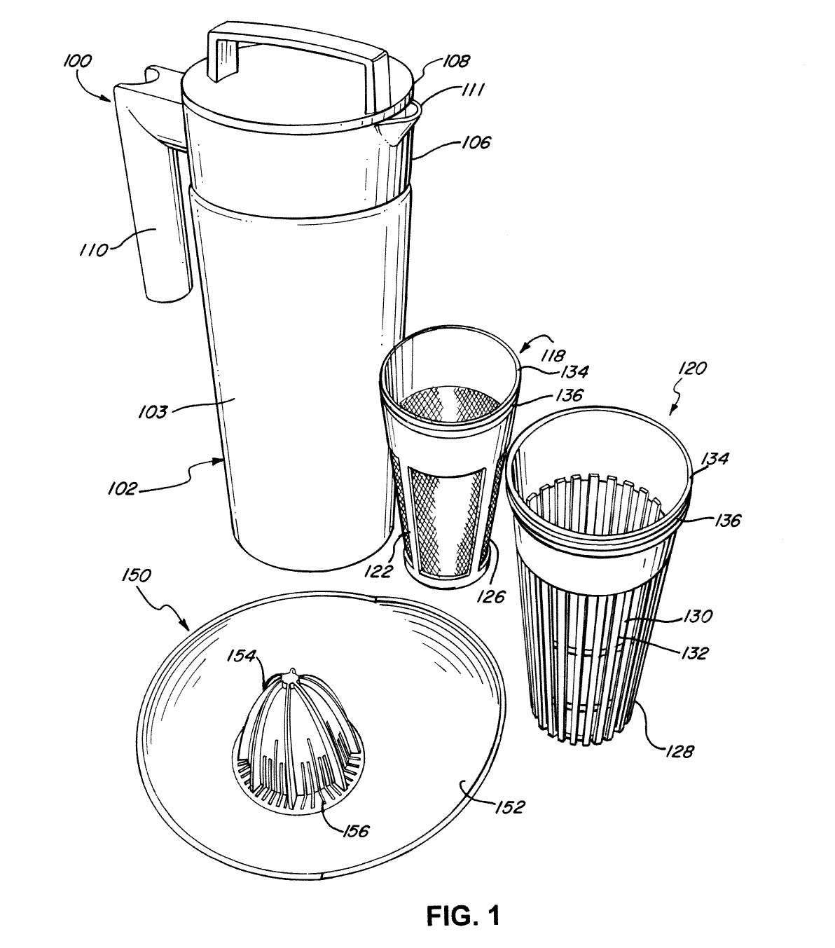

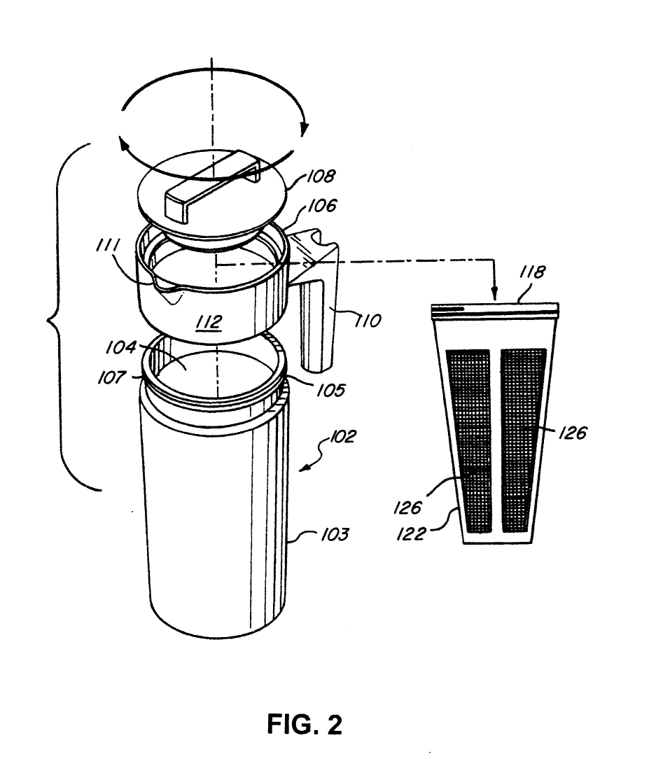

FIG. 1 is a perspective view of a beverage preparation and dispensing system 100 in accordance with an embodiment of this disclosure. The container assembly 100 includes a vessel or container 102, which may be configured as a pitcher, jug, pot or bottle. As best shown in FIG. 2, the container 102 includes a body 103 configured to hold a volume of a potable liquid, the body 103 terminating in an open top end 104 defined by a peripheral rim 105 that is provided with an external thread 107.

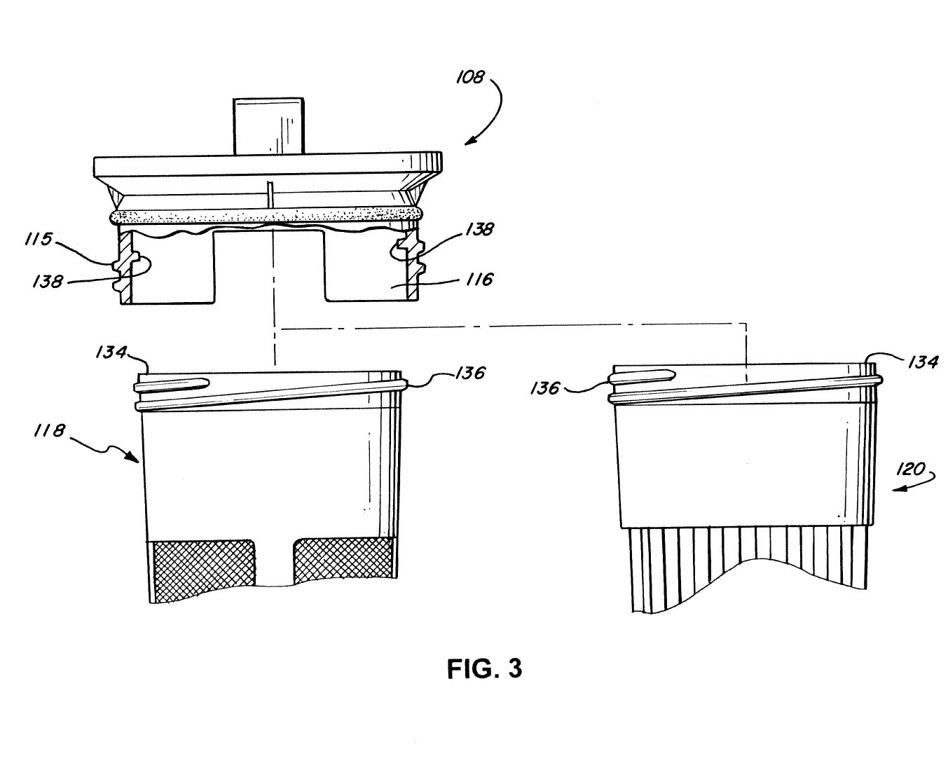

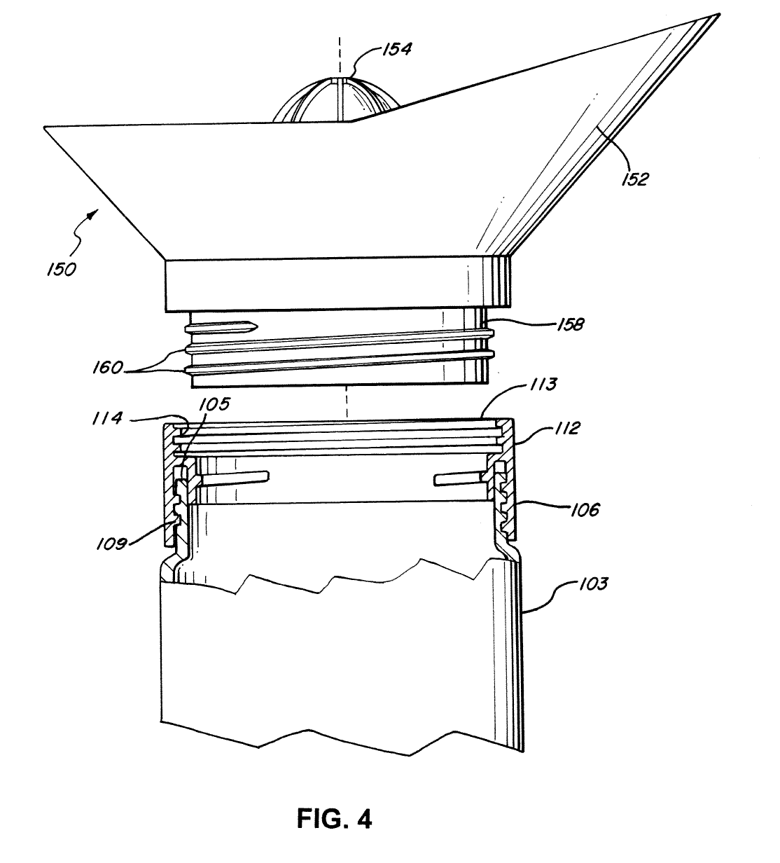

The container 102 also includes a lid assembly comprising a lid ring 106 and a cover 108. The lid ring 106 is removably attachable around the container rim 105 by means of an internal thread 109 (FIG. 4) that engages with the external thread 107 of the rim 105. The lid ring 106 may advantageously include an integral handle 110 and an integral pouring spout 111 disposed 180 degrees from the handle 110, as is well known. As best shown in FIG. 4, the lid ring 106 has an open upper portion 112 that extends above rim 105 of the container body 103 and that terminates in open upper end 113. The cover 108 is dimensioned to fit on the upper end 113 of the lid ring 106 so as to cover the open end 104 of the container body 103. The upper portion 112 of the lid ring 106 is advantageously provided with an internal thread 114 (best shown in FIG. 4) that engages a mating external thread 115 on a downwardly-extending annular flange or skirt 116 of the cover 108 (see FIG. 3), so that the cover 108 is removably attachable to the upper portion 112 of the lid ring 106.

Referring again to FIG. 1, in one embodiment, the system 100 includes at least a first infuser 118 and a second infuser 120. Each of the infusers 118, 120 is configured and dimensioned to hold a quantity of a beverage flavorant (not shown). The first infuser 118 includes a closed-bottom receptacle or basket 122. The basket 122 is configured to contain an herbal flavorant, such as tea leaves, herbal tea flavorants, or the like. For this purpose, the basket 122 advantageously has side walls 126 formed as a mesh or screen, thereby allowing liquid in the container 102 to enter and leave the basket 122 through the mesh or screen side walls 126. The second infuser 120 likewise includes a receptacle or basket 128, but it is advantageously configured to hold fruit flavorants, such as crushed fruit or fruit pulp. Thus, the basket 128 of the second infuser 120 advantageously includes side walls formed by longitudinal ribs 130 defining an array of longitudinal apertures or slots 132, whereby the flavorant in the basket 128 is exposed to liquid in the container that flows through the basket 128. The slots 132 thus serve as flow passages through the basket 128 for the liquid in the container. This flow-through function may, of course, be provided by passages or apertures having any of a wide variety of configurations, and the rib-and-slot configuration shown in the drawings is merely exemplary.

As shown in FIGS. 1-3, each of the infusers 118, 120 has an open upper end defined by a peripheral rim 134, which is advantageously provided with an external thread 136. As shown in FIG. 3, the external thread 136 around the rim 134 of each of the infusers 118, 120 is dimensioned to engage and mate with an internal thread 138 on the interior surface of the flange or skirt 116 of the cover 108. By engagement of the external thread 136 with the internal thread 138, each of the infusers 118, 120 is removably attachable to the bottom of the cover 108. Thus, when one of the infusers 118, 120 is attached to the cover 108, and the cover 108 is then installed in the top portion 112 of the lid ring 106, as described above, the attached infuser (along with the flavorant contained in it) is introduced into the interior of the container 102, thereby exposing a liquid (e.g., water) contained in the container 102 to the flavorant. Thus, for example, the first infuser 118 can be installed and used to flavor water in the container with an herbal flavorant, such as tea, after which the first infuser 118 can be removed and replaced with the second infuser 120 to flavor the beverage with a second flavorant, such as fruit.

Referring now to FIGS. 1 and 4, a juice extractor or juicer device 150 for use in the system 100 is shown. As in conventional juice extractors, the juicer device 150 comprises a basin 152 and a fruit-reaming element 154 projecting upwardly from the approximate center of the basin 152. A plurality of passages, such a slits or apertures 156, are provided in the basin 152 in the proximity of the reaming element 154, for the passage of juice extracted from a fruit by the reaming element 154, as is well-known. The juicer device 150 differs, however, from conventional juice extractors in that it includes an annular flange or skirt 158 extending downward from the basin 152, the flange 158 being provided with an external thread 160. The thread 160 on the juicer device flange or skirt 158 engages and mates with the above-described internal thread 114 on the upper portion 112 of the lid ring 106. By this mechanism, the juicer device 150 is removably attachable to the upper portion 112 of the lid ring 106 when the cover 108 is removed therefrom.

When it is desired to add freshly squeezed fruit juice to the container 102, the cover 108 (and any infuser attached thereto, as described above) is not used. Rather, the juicer device 150 is affixed to the upper portion 112 of the lid ring 106, as described above, and then used to extract juice from a fruit in the conventional way. The extracted juice flows through the passages 156 into the body 103 of the container 102. The juicer device 150 is then removed, and it may be replaced by the cover 108, with or without one of the infusers 118, 120 attached thereto.

It will be appreciated that other embodiments of the system 100 may include the juicer device 150 and only a single infuser, or they may include more than two different types of infusers. Alternatively, the system may include two or more of single type of infuser, so that one may be used while the other is being cleaned, for example. In any of these embodiments, a beverage having both an infused flavorant and fresh-squeezed juice, or a beverage having two or more different kinds of infused flavorants, may be prepared in and dispensed from a single container.

It will be appreciated that, in alternative embodiment, the beverage preparation and dispensing system of the present disclosure may omit the lid ring. In this alternative embodiment, the container body 103 would have an internal thread (not shown) around the open top end 104, with an optional handle and spout formed integrally with the container body at diametrically opposite sides of the open top end 104. The cover 108 in this embodiment is removably attachable directly to the top end of the container body by engagement between the external thread 115 on the cover 108 and the internal thread around the top end of the container body. Likewise, the juicer 150 is removably attachable directly to the top end of the container body, when the cover has been removed, by engagement between the external thread 160 on the juicer and the internal thread around the top end of the container body.

In still another alternative embodiment, the various components may be removably attachable to each other by means of a friction fit, instead of a threaded engagement.

Although the present disclosure has been described with reference to specific embodiments, these embodiments are illustrative only and not limiting. Many other applications and embodiments of the present disclosure will be apparent in light of this disclosure and the following claims.

1. A beverage preparation and dispensing system, comprising:
a container having an open top end and configured to hold a volume of a potable liquid;
a cover having a bottom portion by which the cover is removably attachable to the top end of the container;
at least first and second infusers removably attachable to the bottom portion of the cover, each of the infusers configured to hold a flavorant so as to be exposed to the potable liquid in the container; and
a juicer device removably attachable to the top end of the container when the cover is removed.

2. The beverage preparation and dispensing system of claim 1, wherein the container comprises:
a container body having an open top; and
a lid ring having a bottom portion removably attachable to the open top of the container body and a top portion defining the open top end of the container to which the cover and the juicer device are removably attachable.

3. The beverage preparation and dispensing system of claim 1, wherein at least a first one of the infusers is configured to hold an herbal flavorant, and at least a second one of the infusers is configured to hold a fruit flavorant.

4. The beverage preparation and dispensing system of claim 3, wherein the first one of the infusers comprises a first receptacle having a mesh side wall that allows the passage of the potable liquid through the receptacle.

5. The beverage preparation and dispensing system of claim 3, wherein the second one of the infusers comprises a second receptacle having a side wall that includes a plurality of liquid flow passages that allow the passage of the potable liquid through the second receptacle.

6. The beverage preparation and dispensing system of claim 5, wherein the side wall of the second receptacle comprises an array of longitudinal ribs defining slots therebetween that provide the liquid flow passages.

7. The beverage preparation and dispensing system of claim 1, wherein the first and second infusers are removably attachable to the bottom of the cover by a threaded engagement.

8. The beverage preparation and dispensing system of claim 1, wherein the cover and the juicer device are removably attachable to the top end of the container by a threaded engagement.

9. The beverage preparation and dispensing system of claim 2, wherein the cover and the juicer device are removably attachable to the top portion of the lid ring by a threaded engagement.

10. A beverage preparation and dispensing system, comprising:
a container body having an open top and configured to hold a volume of a potable liquid;
a lid ring having an open top portion and an open bottom portion removably attachable to the open top of the container body;
a cover having a bottom portion by which the cover is removably attachable to the open top portion of the lid ring;
a first infuser, comprising a first receptacle having an open upper end defined by a peripheral rim that is removably attachable to the bottom portion of the cover, the first receptacle having a mesh side wall configured for the passage of the potable liquid through the first receptacle;
a second infuser, comprising a second receptacle having an open upper end defined by a peripheral rim that is removably attachable to the bottom portion of the cover, the second receptacle having a side wall provided with a plurality of liquid flow passages configured for the passage of the potable liquid through the second receptacle; and
a juicer device removably attachable to the top portion of the lid ring when the cover is removed.

11. The beverage preparation and dispensing system of claim 10, wherein the first receptacle is configured to hold an herbal flavorant, and the second receptacle is configured to hold a fruit flavorant.

12. (canceled)

13. The beverage preparation and dispensing system of claim 10, wherein the second receptacle has a side wall that comprises an array of longitudinal ribs defining slots therebetween that provide the liquid flow passages.

14. The beverage preparation and dispensing system of claim 10, wherein the peripheral rims of the first and second infusers are removably attachable to the bottom portion of the cover by a threaded engagement.

15. The beverage preparation and dispensing system of claim 10, wherein the cover and the juicer device are removably attachable to the top portion of the lid ring by a threaded engagement.

16. The beverage preparation and dispensing system of claim 10, wherein the cover and the juicer device are removably attachable to the top portion of the lid ring by a threaded engagement.
